(19) United States
(12) Patent Application Publication
(10) Pub. No.: US 2005/0099970 A1
(43) Pub. Date: May 12, 2005

(54) Method and apparatus for mapping TDM payload data

(76) Inventor: David J. Halliday, West Leake (GB)

Correspondence Address: MOTOROLA, INC., Corporate Law Department - #56-238, 3102 North 56th Street, Phoenix, AZ, 85018, US

(21) Appl. No.: 10/702,749

(22) Filed: Nov. 6, 2003

(51) Int. Cl. H04B 7/212

(52) U.S. Cl. 370/321

(57) ABSTRACT

A method and apparatus includes a DS3 framer (122) receiving a DS3 signal (150) having TDM payload data (152) at a line interface node (102, 104). A logic unit (124) at the line interface node maps the DS3 signal to a packet-based Cframe (156) at the line interface node, wherein the packet-based Cframe includes the TDM payload data (152). The packet-based Cframe having the TDM payload data is distributed over a packet switched backplane (110) using a Common Switch Interface (115) to one or more of a plurality of payload nodes (106, 108, 112).

### BACKGROUND OF THE INVENTION

Prior art methods of receiving time division multiplexed (TDM) signals into a chassis-type network includes channeling DS3 signals to each individual payload node or using dedicated path (as provided in H.110) to distribute DS3 signals to payload nodes within a chassis. These prior art methodologies have the disadvantage of limiting the number of signals that can be channeled through each payload node in the chassis. Another disadvantage is the lack of provisions for reliable failover mechanisms if a payload node fails.

Accordingly, there is a significant need for an apparatus and method that overcomes the disadvantages of the prior art outlined above.

### BRIEF DESCRIPTION OF THE DRAWINGS

Referring to the drawing:

FIG. 1 depicts a block diagram of a multi-service platform system according to one embodiment of the invention;

FIG. 2 illustrates a packet-based Cframe in accordance with an embodiment of the invention; and

FIG. 3 illustrates a flow diagram according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures, software blocks and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical, electrical, or logical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

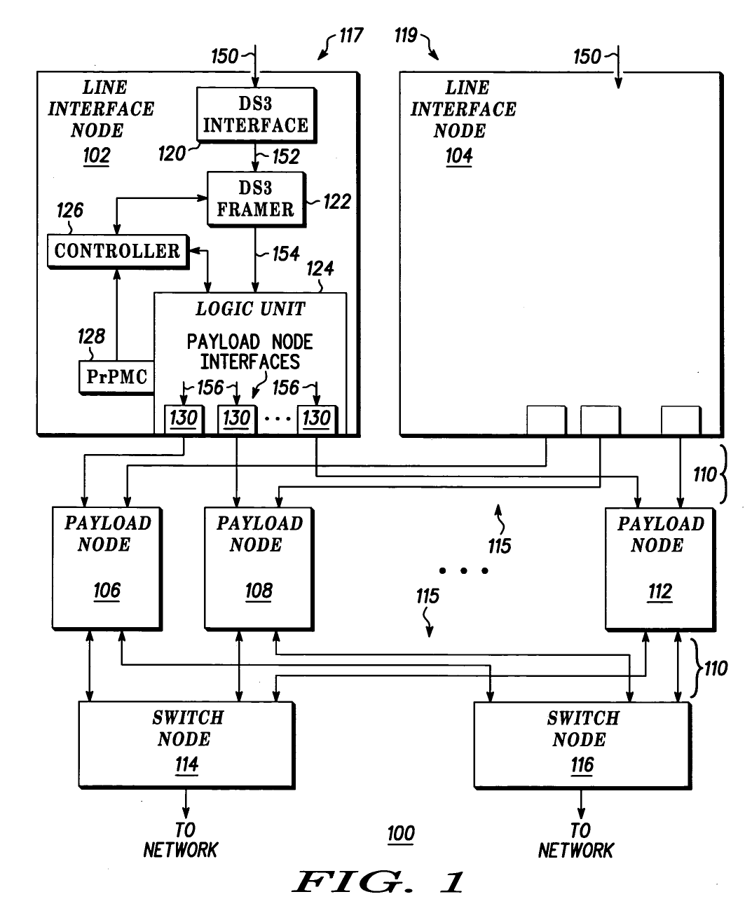

FIG. 1 depicts a block diagram of a multi-service platform system 100 according to one embodiment of the invention. Multi-service platform system 100 can include a multi-service platform system chassis, with software and any number of slots for inserting nodes, for example, first line interface node 102, second line interface node 104, switch nodes 114, 116 and payload nodes 106, 108, 112. Packet switched backplane 110 is used for connecting nodes placed in slots. As an example of an embodiment, a multi-service platform system 100 can include chassis having model MVME5100 manufactured by Motorola Computer Group, 2900 South Diablo Way, Tempe, Ariz. 85282. The invention is not limited to this model or manufacturer and any multi-service platform system is included within the scope of the invention.

As shown in FIG. 1, multi-service platform system 100 can comprise a switch node 114, 116, a first line interface node 102 and a second line interface node 104 coupled to any number of payload nodes 106, 108, 112 via packet switched backplane 110. In an embodiment, first and second line interface nodes 102, 104 can be inserted into slots of multi-service platform system 100 to provide an interface for non-packetized signals received by multi-service platform system 100. For example, first and second line interface nodes can receive time division multiplex (TDM) based signals. As an example of an embodiment, first and second line interface nodes 102, 104 can each be a line interface card.

Payload node 106, 108, 112 can add functionality to multi-service platform system 100 through the addition of processors, memory, storage devices, I/O elements, and the like. In other words, payload node 106, 108, 112 can include any combination of processors, memory, storage devices, I/O elements, and the like, to give multi-service platform system 100 the functionality desired by a user. In an embodiment, there are 18 payload slots for 18 payload nodes in multi-service platform system 100. However, any number of payload slots and payload nodes are included in the scope of the invention.

In an embodiment, multi-service platform system 100 can use switch node 114, 116 as a central switching hub with any number of payload nodes 106, 108, 112 coupled to switch node 114, 116. Switch node 114, 116 can further distribute packetized traffic to other Internet Protocol (IP) based networks.

Multi-service platform system 100 can be based on a point-to-point, switched input/output (I/O) fabric. Multi-service platform system 100 can include both node-to-node (for example computer systems that support I/O node add-in slots) and chassis-to-chassis environments (for example interconnecting computers, external storage systems, external Local Area Network (LAN) and Wide Area Network (WAN) access devices in a data-center environment). Multi-service platform system 100 can be implemented by using one or more of a plurality of switched fabric network standards, for example and without limitation, InfiniBand™, Serial RapidIO™, Ethernet™, and the like. Multi-service platform system 100 is not limited to the use of these switched fabric network standards and the use of any switched fabric network standard is within the scope of the invention. In another embodiment, multiple switch nodes 114, 116 can be used in multi-service platform system 100.

In one embodiment, packet switched backplane 110 can be an embedded packet switched backplane as is known in the art. In another embodiment, packet switched backplane 110 can be an overlay packet switched backplane that is overlaid on top of a backplane that does not have packet switched capability. In an embodiment of the invention, first and second line interface nodes 102, 104 and switch nodes 114, 116 are coupled to payload node 106, 108, 112 via packet switched backplane 110. In an embodiment, packet switched backplane 110 comprises plurality of packet-based links capable of transmitted packet-based signals from/to first and second line interface nodes 102, 104, switch nodes 114, 116 and payload node 106, 108, 112. As an example of an embodiment, each of plurality of packet-based links can comprise two 100-ohm differential signaling pairs per channel. Each channel can use high-speed serialization/deserialization (SERDES) and 8b/10b encoding at speeds up to 3.125 Gigabits per second (Gb/s).

In an embodiment, packet switched backplane 110 can use the CompactPCI Serial Mesh Backplane (CSMB) standard as set forth in PCI Industrial Computer Manufacturers Group (PCIMG®) specification 2.20, promulgated by PICMG, 301 Edgewater Place, Suite 220, Wakefield, Mass. CSMB provides infrastructure for applications such as Ethernet, Serial RapidIO, other proprietary or consortium based transport protocols, and the like. In another embodiment multi-service platform system 100 can use an Advanced Telecom and Computing Architecture (AdvancedTCA™) standard as set forth by PICMG.

In another embodiment, packet switched backplane 110 can use VERSAmodule Eurocard (VMEbus) switched serial standard backplane (VXS) as set forth in VITA 41 promulgated by VMEbus International Trade Association (VITA), P.O. Box 19658, Fountain Hills, Ariz., 85269 (where ANSI stands for American National Standards Institute). VXS includes a packet switched network on a backplane coincident with the VMEbus parallel-type bus, where VMEbus is a parallel multi-drop bus network that is known in the art.

Multi-service platform system 100 can utilize, for example and without limitation, Common Switch Interface 115 for communication. Common Switch Interface 115 is defined in the Common Switch Interface Specification (CSIX) as promulgated by CISX, 2130 Hanover Street, Palo Alto, Calif. CSIX defines electrical and packet control protocol layers for traffic management and communication in packet switched backplane 110. Packet traffic can be serialized over links suitable for a backplane environment. The CSIX packet protocol encapsulates any higher-level protocols allowing interoperability in an open architecture environment.

In an embodiment, first line interface node 102 can receive any number of DS3 signals 150. DS3 signal 150 represents one of a series of standard digital transmission rates based on DS0, a transmission rate of 64 kilobites per second (Kbps), the bandwidth normally used for one telephone voice channel. DS1, used as the signal in a T-1 carrier, carries a multiple of 24 DS0 signals or 1.544 Megabits per second (Mbps). DS3, the signal in a T-3 carrier, carries a multiple of 28 DS 1 signals or 672 DS0 signals or 44.74 Mbps. In an embodiment, first line interface node 102 can receive any number of DS3 signals.

Line interface node 102, 104 can include, for each DS3 signal, DS3 interface 120, which can be the physical connection allowing line interface node 102 to receive DS3 signal 150. For example, DS3 interface 120 can include a BNC or TNC type connector for DS3 signals as is known in the art. In another embodiment, DS3 interface 120 can be an optical connection, such as OC3 optical fibers, or higher capacity fibers, and the like. DS3 signal can include TDM payload data 152, which can be time division multiplexed data, such as telephone voice data, and the like.

In an embodiment, DS3 signal 150 enters DS3 framer 122, which can take the DS3 signal stream and convert it to 8 bit DS0 samples 154. The output from DS3 framer 122 can then enter logic unit 124. Each DS3 signal 114, 116 is interfaced to logic unit 124.

In an embodiment, logic unit 124 can map DS3 signal 150 to packet-based Cframe 156 so that TDM payload data 152 from DS3 signal 150 can be distributed to one or more of plurality of payload nodes 106, 108, 112 via packet switched backplane 110 using Common Switch Interface 115. In an embodiment, logic unit 124 can be a field programmable gate array (FPGA), and the like. In an embodiment, DS3 signal 150 having TDM payload data 152 can be mapped to packet-based Cframe 156 at the DS1 level and distributed over packet switched backplane 110 using Common Switch Interface 115. In other words, DS3 signal 150 can be mapped to packet-based Cframe 156 and transported over packet switched backplane 110 inside a packet-based Cframe 156 of Common Switch Interface 115.

In an embodiment, controller 126 can create a static mapping between a given channelized DS1 and one or more packet-based interfaces 130. Logic unit 124 can be pre-provisioned with static mapping of channelized TDM channels from the DS3 framer 122 to one or more packet-based interfaces 130. In this way, a DS1 signal taken from the DS3 signal is mapped into a packet-based Cframe 156 of Common Switch Interface 115 in a pre-specified manner.

In an embodiment, line interface node 102, 104 can include controller 126, which can control logic unit 124. In an embodiment, controller 126 can be an intelligent platform management interface (IPMI) as is known in the art. In a further embodiment, line interface node 102, 104 can include a processor peripheral component interconnect PCI mezzanine card (PrPMC) 128 coupled to any of switch nodes 114, 116 to drive controller 126.

In an embodiment, logic unit 124 is coupled to a packet-based interface 130 for each payload node 106, 108, 112, where packet based interface 130 provides an electrical interface with packet switched backplane 110. In an embodiment, packet-based interface can be low voltage differential signaling (LVDS). In an example of an embodiment, packet based interface 130 can be a standard 100BaseT Ethernet physical connection. In an embodiment, there can be a packet-based interface 130 on line interface node 102, 104 for each payload node 106, 108, 112 coupled to line interface node 102, 104.

Once TDM payload data 152 is placed into packet-based Cframe 156, TDM payload data can then be transported within multi-service platform system 100, for example, inside Common Switch Interface 115 layer 1. This allows a uniform method of encapsulation that supports multi-service multi-class of service environment. In an embodiment, this also allows multi-service platform system 100 to support TDM, IP, Asynchronous Transfer Mode (ATM), Frame Relay traffic, and the like, in a standard format with a uniform Segmentation and Reassembly (SAR) scheme.

In an embodiment, line interface node 102, 104 can channelize incoming DS3 signal 150 having TDM payload data 152. DS3 signal 150 having TDM payload data 152 can then be framed and mapped to packet-based Cframe 156 at the DS1 level. Because framing and mapping occurs at line interface node 102, 104, TDM payload data 152 can be transported around multi-service platform system 100 at the DS1 level and also split off from other signaling traffic to separate signaling gateways resident within multi-service platform system 100. In other words, DS3 signal 150 can be mapped to packet-based Cframe 156 and transported over packet switched backplane 110 inside a packet-based Cframe 156 of Common Switch Interface 115. In an embodiment, line interface node 102, 104 can be under control of the system manager of multi-service platform system 100.

Software blocks that perform embodiments of the invention are part of computer program modules comprising computer instructions, such as control algorithms, that are stored in a computer-readable medium such as memory at logic unit 124. Computer instructions can instruct processors to perform methods of receiving and processing DS3 signals in a multi-service platform system 100, particularly at first and second line interface node 102, 104. In other embodiments, additional modules could be provided as needed.

In an embodiment, DS3 interface 120 on both first line interface node 102 and second line interface node 104 can be configured for 1+1 automatic protection switching (APS) to work as a redundant pair. In this configuration, DS3 signal 150 is received and processed at both first line interface node 102 and second line interface node 104 in a redundant fashion in accordance with standard optical Automatic Protection Switching 1+1 operation, and the like. In one embodiment, the first line interface node 102 and second line interface node 104 decide among themselves which will pass TDM payload data 152 to one or more of payload nodes 106, 108, 112. This can be accomplished, for example and without limitation, by each of first and second line interface nodes 102, 104 polling each other to determine which is in active mode 117 and which is in standby mode 119. The one of first and second line interface nodes 102, 104 that is in active mode 117 can then be the one that distributes packet-based Cframe 156 to payload nodes 106, 108, 112. If polling indicates the active node fails, then the active mode 117 and standby mode 119 status can be swapped for first and second line interface nodes 102, 104. Polling can be accomplished, for example, over packet switched backplane 110.

In another embodiment, both first line interface node 102 and second line interface node 104 distribute TDM payload data 152 in packet-based Cframe 156 to each of payload nodes 106, 108, 112. Each of payload nodes 106, 108, 112 then determines from which of the first line interface node 102 or second line interface node 104 to accept packet-based Cframe 156 having TDM payload data 152. If one of payload nodes 106, 108, 112 fails, this permits a graceful failover to an alternate payload node since the TDM payload data 152 is already present at each of payload nodes 106, 108, 112.

In an embodiment, payload nodes 106, 108, 112 can be designed for any custom implementation of processing and further distribution of TDM payload data 152. For example, payload node 106, 108, 112 can include any type of receiver, logic unit and signal processor to receive and process TDM payload data 152. In an embodiment, payload node 106, 108, 112 can receive and process TDM payload data 152 from more than one DS3 signal 150.

FIG. 2 illustrates a packet-based Cframe 200 in accordance with an embodiment of the invention. In one embodiment, packet-based Cframe 200 is less than 64 bytes, where 64 bytes is the smallest packet-based Cframe specified in the CSIX specification. In another embodiment, packet-based Cframe 200 is 48 bytes in size, which can provide considerable bandwidth savings over a 64 byte packet-based Cframe.

As shown in FIG. 2, packet-based Cframe 200 includes a CSIX header portion 204 and a Cksum portion 208, which are standard portions of a packet-based Cframe as specified in the CSIX specification. Packet-based Cframe 200 also includes a TDM payload data portion 206, which comprises TDM payload data 152 as mapped from DS3 signal 150.

In an embodiment, TDM payload data portion 206 can comprise a context ID portion 210 that can be used to uniquely identify and differentiate between DS0 signals and other signaling within TDM payload data portion 206. Context ID portion 210 can include addressing data so that different DS0, DS1 signals, other signaling data, and the like, can be identified and separated at payload node 106, 108, 112. Using context ID portion 210, different DS3 signals can be apportioned to different payload nodes 106, 108, 112. In an embodiment, context ID portion 210 can be 3 bytes in size. TDM payload data portion 206 can also include DS0 portion 212 that comprises DS0 data from DS3 signal 150. In an embodiment, DS0 portion 212 can comprise 24 DS0 signals. In another embodiment, DS0 portion 212 can comprise 32 DS0 signals.

Context ID portion 210 can include at least one of DS3 ID portion 214, DS 1 ID portion 216, payload ID portion 218, and frame ID portion 220. In an embodiment, DS3 ID portion 214 can include an 8-bit field to permit payload nodes 106, 108, 112 to associate data from DS0 portion 212 to a particular DS3 signal. In an embodiment, DS1 ID portion 216 can include an 8-bit field to permit payload nodes 106, 108, 112 to identify DS1 data and associate it with a particular DS3 signal.

In an embodiment, payload ID portion 218 can include a 4-bit field to allow payload nodes 106, 108, 112 to identify the type of data in DS0 portion 212. As an example, payload ID portion 218 can set bits to identify the type of data as T1 data (North American style of telephony trunk—24 DS0 signals), E1 data (European telephony trunk—32 DS0 signals), channel associated signaling (CAS) or common channel signaling (CCS) to indicate voice traffic vs. signaling traffic, and conference value which can be a mix of DS0 data. These examples are not limiting of the invention. Any number of payload identifiers or other payload identifier can be used in payload ID portion 218 and be within the scope of the invention.

In an embodiment, frame ID portion 220 can include a 4-bit field to differentiate and identify samples of DS3 data. For example telephony trunks are synchronous and have a sampling frequency of 8 kHz, which equates to a 125 micro second period. Frame ID portion 220 identifies samples taken and ensures that samples are in order and that no samples are lost.

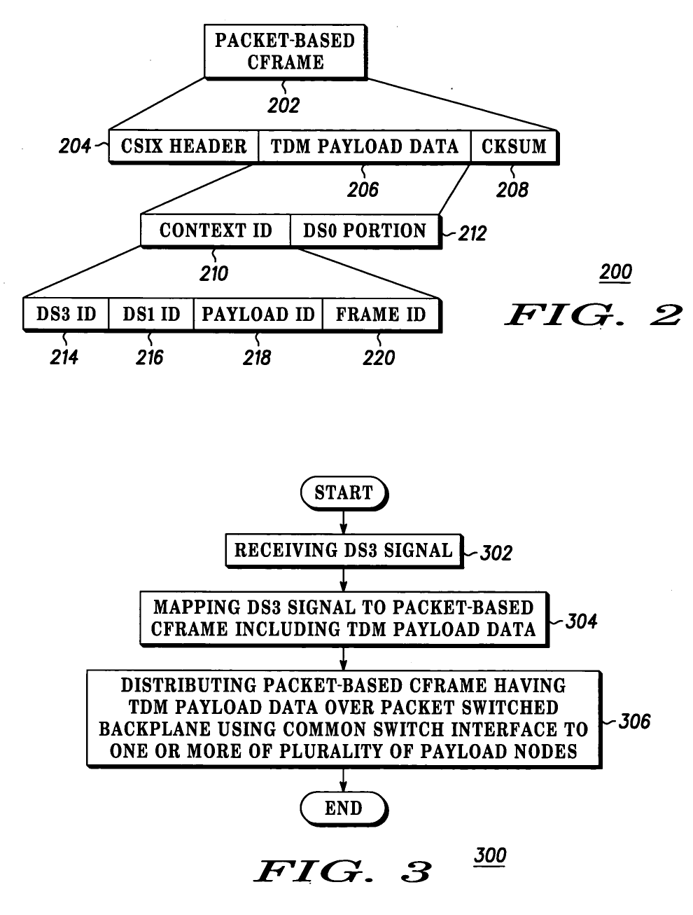

FIG. 3 illustrates a flow diagram 300 according to an embodiment of the invention. Step 302 includes receiving a DS3 signal having TDM payload data at a line interface node. In an embodiment, receiving DS3 signal can include receiving the DS3 signal at a first line interface node and at a second line interface node.

Step 304 includes mapping the DS3 signal to a packet-based Cframe at the line interface node, wherein the packet-based Cframe includes the TDM payload data. Step 306 includes distributing the packet-based Cframe having the TDM payload data over a packet switched backplane using a Common Switch Interface to one or more of a plurality of payload nodes. In an embodiment, distributing includes the first line interface node and the second line interface node distributing the packet-based Cframe having the TDM payload data to the one or more of the plurality of payload nodes. The one or more of the plurality of payload nodes then determines from which of the first line interface node and the second line interface node to accept the packet-based Cframe having the TDM payload data.

In another embodiment, distributing includes determining which of the first line interface node and the second line interface node is in an active mode. One of the first line interface node and the second line interface node that is in the active mode distributes the packet-based Cframe having the TDM payload data to the one or more of the plurality of payload nodes.

While we have shown and described specific embodiments of the present invention, further modifications and improvements will occur to those skilled in the art. It is therefore to be understood that appended claims are intended to cover all such modifications and changes as fall within the true spirit and scope of the invention.

1. A method, comprising:
receiving a DS3 signal having TDM payload data at a line interface node;
mapping the DS3 signal to a packet-based Cframe at the line interface node, wherein the packet-based Cframe includes the TDM payload data; and
distributing the packet-based Cframe having the TDM payload data over a packet switched backplane using a Common Switch Interface to one or more of a plurality of payload nodes.

2. The method of claim 1, wherein the packet-based Cframe is less than 64 bytes.

3. The method of claim 1, wherein the packet-based Cframe is 48 bytes.

4. The method of claim 1, wherein the packet-based Cframe comprises a TDM payload data portion.

5. The method of claim 1, wherein the packet-based Cframe comprises a context ID portion.

6. The method of claim 5, wherein the context ID portion comprises at least one of a DS3 ID portion, a DS1 ID portion, a payload ID portion and a frame ID portion.

7. The method of claim 1, further comprising:
receiving the DS3 signal at a first line interface node and at a second line interface node;
the first line interface node and the second line interface node distributing the packet-based Cframe having the TDM payload data to one or more of the plurality of payload nodes; and
one or more of the plurality of payload nodes determining from which of the first line interface node and the second line interface node to accept the packet-based Cframe having the TDM payload data.

8. The method of claim 1, further comprising:
receiving the DS3 signal at a first line interface node and at a second line interface node;
the first line interface node and the second line interface node polling each other;
determining which of the first line interface node and the second line interface node is in an active mode; and
one of the first line interface node and the second line interface node that is in the active mode distributing the packet-based Cframe having the TDM payload data to one or more of the plurality of payload nodes.

9. A line interface node, comprising:
a DS3 framer, wherein the DS3 framer receives a DS3 signal having TDM payload data; and
a logic unit, wherein the logic unit maps the DS3 signal to a packet-based Cframe having the TDM payload data, wherein the logic unit distributes the packet-based Cframe having the TDM payload data over a packet switched backplane using a Common Switch Interface to one or more of a plurality of payload nodes.

10. The line interface node of claim 9, wherein the packet-based Cframe is less than 64 bytes.

11. The line interface node of claim 9, wherein the packet-based Cframe is 48 bytes.

12. The line interface node of claim 9, wherein the packet-based Cframe comprises a TDM payload data portion.

13. The line interface node of claim 9, wherein the packet-based Cframe comprises a context ID portion.

14. The line interface node of claim 13, wherein the context ID portion comprises at least one of a DS3 ID portion, a DS1 ID portion, a payload ID portion and a frame ID portion.

15. A multi-service platform system, comprising:
a first line interface node coupled to receive a DS3 signal having TDM payload data, wherein the first line interface node maps the DS3 signal to a packet-based Cframe;
a second line interface node coupled to receive the DS3 signal having the TDM payload data, wherein the second line interface node maps the DS3 signal to a packet-based Cframe; and
a plurality of payload nodes, wherein the first fine interface node and the second line interface node distribute the packet-based Cframe having the TDM payload data over a packet switched backplane using a Common Switch Interface to one or more of the plurality of payload nodes.

16. The multi-service platform system of claim 15, one or more of the plurality of payload nodes determines from which of the first line interface node and the second line interface node to accept the packet-based Cframe having the TDM payload data.

17. The multi-service platform system of claim 15, wherein the packet-based Cframe is less than 64 bytes.

18. The multi-service platform system of claim 15, wherein the packet-based Cframe is 48 bytes.

19. The multi-service platform system of claim 15, wherein the packet-based Cframe comprises a TDM payload data portion.

20. The multi-service platform system of claim 15, wherein the packet-based Cframe comprises a context ID portion.

21. The multi-service platform system of claim 20, wherein the context ID portion comprises at least one of a DS3 ID portion, a DS1 ID portion, a payload ID portion and a frame ID portion.

22. A line interface node comprising a computer-readable medium containing computer instructions for instructing a processor to perform a method of mapping and distributing a DS3 signal having a TDM payload, the instructions comprising:
receiving the DS3 signal having the TDM payload data at the line interface node;
mapping the DS3 signal to a packet-based Cframe at the line interface node, wherein the packet-based Cframe includes the TDM payload data; and
distributing the packet-based Cframe having the TDM payload data over a packet switched backplane using a Common Switch Interface to one or more of a plurality of payload nodes.

23. The line interface node of claim 22, wherein the packet-based Cframe is less than 64 bytes.

24. The line interface node of claim 22, wherein the packet-based Cframe is 48 bytes.

25. The line interface node of claim 22, wherein the packet-based Cframe comprises a TDM payload data portion.

26. The line interface node of claim 22, wherein the packet-based Cframe comprises a context ID portion.

27. The line interface node of claim 26, wherein the context ID portion comprises at least one of a DS3 ID portion, a DS1 ID portion, a payload ID portion and a frame ID portion.

28. The line interface node of claim 22, further comprising:
receiving the DS3 signal at a first line interface node and at a second line interface node;
the first line interface node and the second line interface node distributing the packet-based Cframe having the TDM payload data to one or more of the plurality of payload nodes; and
one or more of the plurality of payload nodes determining from which of the first line interface node and the second line interface node to accept the packet-based Cframe having the TDM payload data.

29. The line interface node of claim 22, further comprising:
receiving the DS3 signal at a first line interface node and at a second line interface node;
the first line interface node and the second line interface node polling each other;
determining which of the first line interface node and the second line interface node is in an active mode; and
one of the first line interface node and the second line interface node that is in the active mode distributing the packet-based Cframe having the TDM payload data to one or more of the plurality of payload nodes.
